(19) United States
(12) Patent Application Publication
(10) Pub. No.: US 2024/0361606 A1
(43) Pub. Date: Oct. 31, 2024

(54) OPTICAL ELEMENT AND IMAGE DISPLAY DEVICE

(71) Applicant: Sony Group Corporation, Tokyo (JP)

(72) Inventors: Yoshinori OHASHI, Tokyo (JP); Hideaki OKANO, Aichi (JP); Eiji NOMURA, Tokyo (JP)

(73) Assignee: Sony Group Corporation, Tokyo (JP)

(21) Appl. No.: 18/683,634

(22) PCT Filed: Mar. 18, 2022
(86) PCT No.: PCT/JP2022/012591

§ 371 Date: Feb. 14, 2024

(30) Foreign Application Priority Data
Aug. 30, 2021 (JP) 2021-140275

(51) Int. Cl. G02B 27/09; G02B 27/01

(52) U.S. Cl. CPC G02B 27/0972; G02B 27/0172; G02B 2027/0178

(57) ABSTRACT

The optical element is thinned. The optical element includes a first prism and a second prism. The first prism includes an incident surface, a semi-reflecting surface, and an emitting surface each configured of a free-form surface, and in which the light of a display element is incident from the incident surface, internally reflected between the emitting surface and the semi-reflecting surface, and emitted from the emitting surface to an observation portion of the light. The second prism includes an external light incident surface configured in a shape in which a free-form surface is divided by at least one stepped surface and on which external light is incident, and an external light emitting surface from which the incident external light is emitted to the semi-reflecting surface.

### FIELD

The present disclosure relates to an optical element and an image display device.

### BACKGROUND

A head mounted display device is used. This display device is called a head mounted display, and is a display device that guides light from a display element such as a liquid crystal display element disposed in the vicinity of an eyeball to the eyeball by a display optical system such as a prism. In such a display device, a display device that transmits external light has been proposed. For example, as a display optical system, a display device including a free-form surface prism including an incident surface on which light is incident from a display element, a reflecting surface, and a surface emitting light to an eyeball, and a correction prism that transmits external light has been proposed (See, for example, Patent Literature 1). In this display device, the incident light from the incident surface of the free-form surface prism is sequentially reflected by the surface and the reflecting surface and emitted from the surface. Further, the correction prism has a surface having the same shape as the reflecting surface of the free-form surface prism and the surface emitting light to the eyeball, and is disposed to be joined to the free-form surface prism. External light incident on the correction prism is emitted to the eyeball through the free-form surface prism.

### CITATION LIST

### Patent Literature

Patent Literature 1: JP2004-185023A

### SUMMARY

### Technical Problem

However, in the related art described above, since the correction prism is configured of a surface having the same shape as the free-form surface prism, there is a problem that the thickness of the display optical system increases. For this reason, there is a problem that it is difficult to miniaturize the display device of the related art.

Therefore, the present disclosure proposes an optical element and an image display device having a thin display optical system.

### Solution to Problem

An optical element according to the present disclosure includes: a first prism that includes an incident surface, a semi-reflecting surface, and an emitting surface each configured of a free-form surface, and in which light of a display element is incident from the incident surface, is internally reflected between the emitting surface and the semi-reflecting surface, and is emitted from the emitting surface to an observation portion of the light; and a second prism including an external light incident surface configured in a shape in which a free-form surface is divided by at least one stepped surface and on which external light is incident, and an external light emitting surface from which the incident external light is emitted to the semi-reflecting surface.

### BRIEF DESCRIPTION OF DRAWINGS

FIG. 1 is a diagram illustrating a configuration example of an image display device according to an embodiment of the present disclosure.

FIG. 2A is a cross-sectional view illustrating a configuration example of an image display device according to a first embodiment of the present disclosure.

FIG. 2B is a bottom view illustrating a configuration example of the image display device according to the first embodiment of the present disclosure.

FIG. 3 is a cross-sectional view illustrating another configuration example of the image display device according to the first embodiment of the present disclosure.

FIG. 4A is a diagram illustrating an arrangement example of the image display device according to the embodiment of the present disclosure.

FIG. 4B is a diagram illustrating an arrangement example of the image display device according to the embodiment of the present disclosure.

FIG. 5 is a cross-sectional view illustrating a configuration example of an image display device according to a second embodiment of the present disclosure.

FIG. 6 is a cross-sectional view illustrating another configuration example of the image display device according to the second embodiment of the present disclosure.

FIG. 7 is a cross-sectional view illustrating a configuration example of an image display device according to a third embodiment of the present disclosure.

### DESCRIPTION OF EMBODIMENTS

Hereinafter, embodiments of the present disclosure will be described in detail with reference to the drawings. The description will be given in the following order. In each of the following embodiments, the same parts are denoted by the same reference numerals, and the duplicate description will be omitted.
1. First Embodiment
2. Second Embodiment
3. Third Embodiment

### 1. First Embodiment

### [Configuration of Image Display Device]

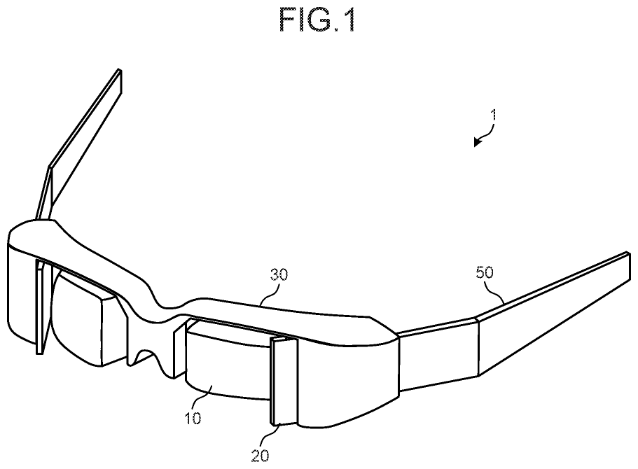

FIG. 1 is a diagram illustrating a configuration example of an image display device according to an embodiment of the present disclosure. The present drawing is a diagram illustrating a configuration example of an image display device 1. The image display device 1 is a head mounted image display device that guides external light to an eyeball of a user while guiding an image from a display element to the eyeball of the user. The user of the image display device 1 can observe an image in which an image of the display element is superimposed on an image of the outside world based on the external light. The image display device 1 is configured by disposing a display element 20 and an optical element 10 in a housing 30.

The display element 20 displays an image. The display element 20 can be configured of, for example, an organic light emitting diode (OLED). The light of a display image of the display element 20 is incident on the optical element 10. Note that another element, for example, a liquid crystal display element can also be applied to the display element 20.

The optical element 10 guides light from the display element 20 to the eyeball of the user. In addition, the optical element 10 guides external light to the eyeball of the user. The details of the configuration of the optical element 10 will be described later.

The housing 30 holds the display element 20 and the optical element 10. In addition, the housing 30 further holds a drive circuit (not illustrated) of the display element 20. Temples 50 in the drawing fix the housing 30 to the user's head. The temple 50 can be configured to be put on the user's ear. It is also possible to adopt a configuration in which a headband is disposed on the temple 50 and the housing 30 is fixed by the headband.

Note that the drawing illustrates an example of the image display device 1 in which the display element 20 and the optical element 10 are arranged on the left and right of the housing 30.

### [Configuration of Image Display Device]

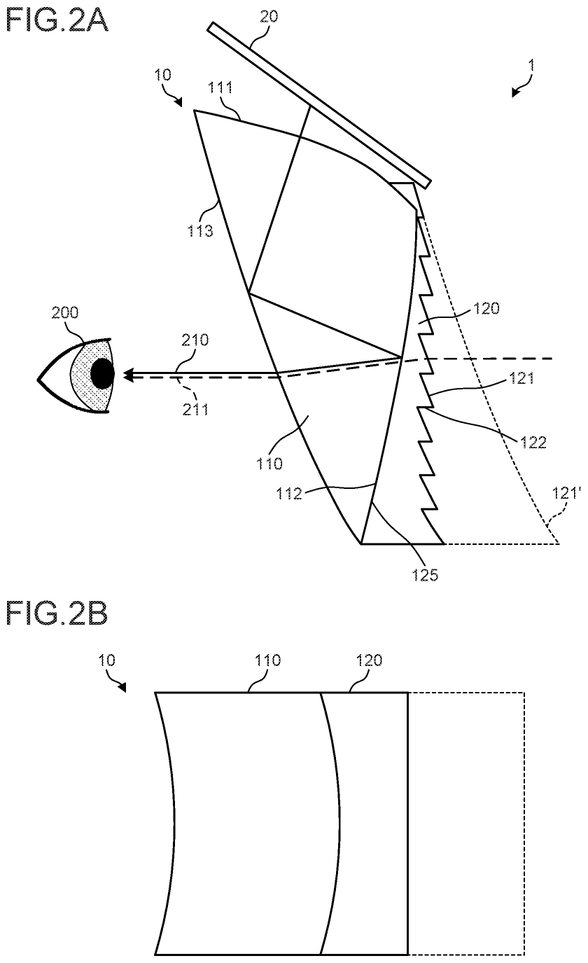

FIG. 2A is a cross-sectional view illustrating a configuration example of an image display device according to a first embodiment of the present disclosure. The present drawing is a schematic cross-sectional view illustrating a configuration example of the image display device 1. In the drawing, illustration of the housing 30 is omitted. As described above, the image display device 1 includes the display element 20 and the optical element 10. The optical element 10 in the drawing includes a first prism 110 and a second prism 120.

The first prism 110 is a free-form surface prism including an incident surface 111, a semi-reflecting surface 112, and an emitting surface 113 each configured of a free-form surface. In the first prism 110, the light of the display element 20 is incident from the incident surface 111, internally reflected between the emitting surface 113 and the semi-reflecting surface 112, and then emitted from the emitting surface 113 to an observation portion of the light. Note that the present drawing illustrates an eyeball 200 of the user of the image display device 1 as an example of the observation portion. The light flux of the image of the display element 20 is guided to the eyeball 200 and enlarged by the first prism 110. The user of the image display device 1 observes a virtual image in which the image of the display element 20 is enlarged. A solid arrow in the drawing represents an optical path 210 of the light from the display element 20.

The second prism 120 is a prism including an external light incident surface 121 and an external light emitting surface 125. The second prism 120 can be disposed adjacent to the semi-reflecting surface 112 of the first prism 110, and can emit incident external light to the observation portion through the first prism 110. The external light incident surface 121 is a surface configured in a shape in which a free-form surface is divided by at least one stepped surface 122 and on which external light is incident. The external light emitting surface 125 is a surface from which the incident external light is emitted. In addition, the external light emitting surface 125 can emit the incident external light to the semi-reflecting surface 112. Furthermore, the external light emitting surface 125 can be formed in the same shape as the semi-reflecting surface 112 and can be formed as a surface joined to the semi-reflecting surface 112. A solid arrow in the drawing represents an optical path 211 of the external light.

As illustrated in the drawing, the external light incident surface 121 is configured in a shape of a free-form surface is divided by a stepped surface 122. The external light incident surface 121 in the drawing represents an example of the external light incident surface 121 divided by nine stepped surfaces 122. The external light incident surface 121 can employ a shape having any number of stepped surfaces 122. In addition, the present drawing illustrates an example in which the plurality of stepped surfaces 122 are arranged in parallel.

In addition, the external light incident surface 121 in the drawing may have a shape in which a free-form surface having the same shape as the emitting surface 113 of the first prism 110 is divided by at least one stepped surface 122. In this case, the external light incident surface 121 excluding the stepped surface 122 is a curved surface parallel to the emitting surface 113. Therefore, phase information of external light is held. That is, it is possible to align the directions of the light flux of the external light incident on the external light incident surface 121 and the light flux of the external light emitted from the emitting surface 113. As a result, the user of the image display device 1 can view an image of the outside world without distortion.

A broken line in the drawing represents an outer shape of the second prism 120 including an external light incident surface 121′ on which the stepped surface 122 is not disposed. The external light incident surface 121′ has a shape obtained by translating the emitting surface 113. In this case, since the external light incident surface 121′ having the same shape as the emitting surface 113 is a free-form surface having an inclination, the thickness of the bottom surface of the second prism 120 increases. On the other hand, by disposing the stepped surface 122 on the external light incident surface 121 to divide the free-form surface, the bottom portion of the second prism 120 can be thinned. This makes it possible to prevent an increase in the thickness of the optical element 10 including the first prism 110.

FIG. 2B is a bottom view illustrating a configuration example of the image display device according to the first embodiment of the present disclosure. The present drawing is a diagram illustrating a configuration example of a bottom surface of the optical element 10. Also in the drawing, the outer shape of the second prism 120 including the external light incident surface 121′ on which the stepped surface 122 is not arranged is indicated by a broken line. By adopting the external light incident surface 121 having the stepped surface 122, the bottom portion of the optical element 10 can be thinned.

The image display device 1 illustrated in FIGS. 2A and 2B can improve the optical magnification by disposing the first prism 110 having three free-form surfaces. For example, when the display element 20 having a diagonal of 1 inch is used, a field of view of 53.7° in the horizontal direction and 49.5° in the vertical direction can be obtained. In this case, the optical magnification is 130 times in the horizontal direction and 109 times in the vertical direction.

In addition, in FIG. 2A, the second prism 120 includes the external light incident surface 121 having a plurality of stepped surfaces 122. Since these stepped surfaces 122 are parallel to each other, the processing angle of the stepped surface 122 of the second prism 120 becomes uniform, and processability and productivity can be improved.

In addition, the light from the display element 20 is refracted twice by being incident on the first prism 110 and being emitted from the first prism 110, and is reflected twice by total reflection by the emitting surface 113 and reflection by the semi-reflecting surface 112 in the first prism 110. Among these, since the attenuation of the light from the display element 20 occurs only when reflected by the semi-reflecting surface 112, the luminance efficiency of the image display device 1 can be improved.

### [Another Configuration of Image Display Device]

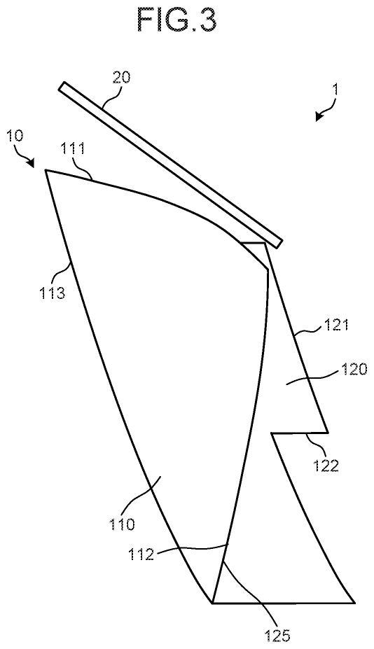

FIG. 3 is a cross-sectional view illustrating another configuration example of the image display device according to the first embodiment of the present disclosure. The present drawing is a schematic cross-sectional view illustrating a configuration example of the image display device 1, similarly to FIG. 2A. The second prism 120 in the drawing is different from the image display device 1 in FIG. 2A in that the external light incident surface 121 having one stepped surface 122 is included. Also in the optical element 10 in the drawing, the increase in the thickness of the bottom portion of the second prism 120 can be reduced by disposing the stepped surface 122 on the external light incident surface 121.

### [Arrangement of Image Display Device]

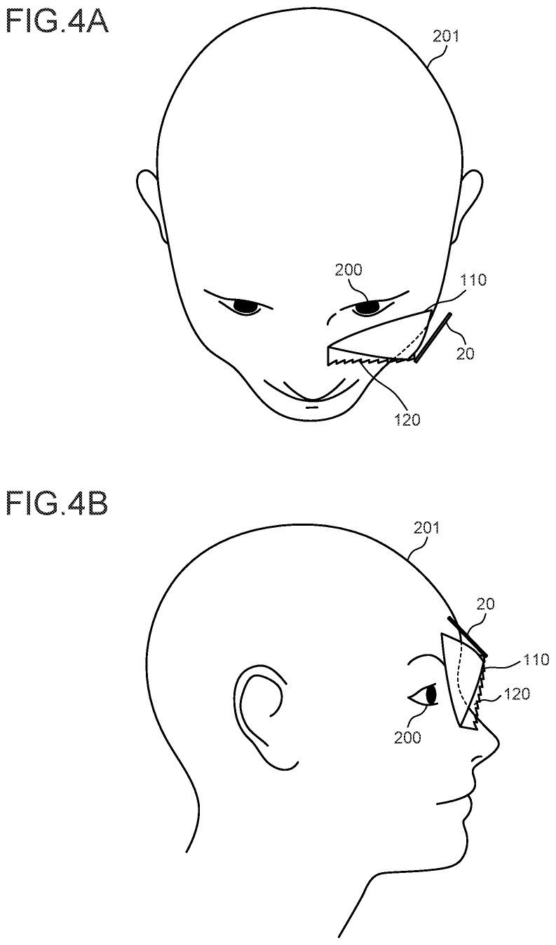

FIGS. 4A and 4B are diagrams illustrating an arrangement example of the image display device according to the embodiment of the present disclosure. Note that illustration of the housing 30 and the like is omitted in the drawing.

FIG. 4A illustrates an example in which the display element 20 is disposed on a side of the eyeball 200 of a user 201. In the optical element 10 in the drawing, the ear side of user 201 becomes thicker, and the nose side becomes thinner. In the arrangement in this drawing, the optical element 10 can be designed to be integrated with the temple 50, and a natural appearance can be obtained.

FIG. 4B illustrates an example in which the display element 20 is disposed above the eyeball 200 of the user 201. In the arrangement in the drawing, an incident range of external light of the optical element 10 can be widened.

Note that the configuration of the image display device 1 is not limited to this example. For example, it is also possible to adopt a configuration in which a camera is arranged instead of the eyeball 200 of the user.

As described above, in the optical element 10 according to the first embodiment of the present disclosure, the optical element 10 can be thinned by disposing the second prism 120 including the external light incident surface 121 having the stepped surface 122.

### 2. Second Embodiment

The image display device 1 of the first embodiment described above uses the second prism 120 including the external light incident surface 121 having the plurality of parallel stepped surfaces 122. On the other hand, an image display device 1 according to a second embodiment of the present disclosure is different from the above-described first embodiment in that the external light incident surface 121 having a stepped surface 122 inclined along an optical path from the observation portion is included.

### [Configuration of Image Display Device]

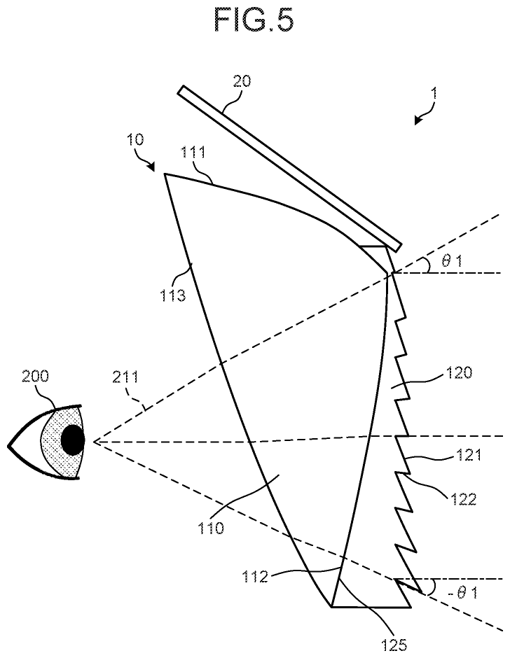

FIG. 5 is a cross-sectional view illustrating a configuration example of the image display device according to the second embodiment of the present disclosure. The present drawing is a schematic cross-sectional view illustrating a configuration example of the image display device 1, similarly to FIG. 2A. The external light incident surface 121 of the second prism 120 in the drawing is different from the image display device 1 in FIG. 2A in that the stepped surface 122 inclined along the optical path from the observation portion is included.

The stepped surface 122 in the drawing is configured to be inclined along the optical path 211 from the eyeball 200 of the user of the image display device 1 as the observation portion. In this case, the plurality of stepped surfaces 122 are formed at different angles. Specifically, the stepped surface 122 at the central portion of the external light incident surface 121 is formed at a substantially horizontal angle, and the stepped surface 122 at the end portion of the external light incident surface 121 is formed at an angle according to the elevation angle and the depression angle from the eyeball 200 of the user of the image display device 1. The angle of the stepped surface 122 at the end portion of the second prism 120 is ±θ1 with respect to the horizontal direction. For example, an angle of a value “28” can be applied to θ1.

If the external light incident surface 121 having the parallel stepped surfaces 122 is used as in the second prism 120 in FIG. 2A, a phenomenon called ghost occurs in which virtual images are perceived side by side. This is because internal reflection of the optical element 10 occurs. Therefore, the stepped surface 122 of the external light incident surface 121 is configured to be inclined along the optical path 211 from the eyeball 200 of the user of the image display device 1 as the observation portion. As a result, internal reflection of the optical element 10 can be reduced, and a ghost when viewing the central portion of the optical element 10 can be reduced.

It is preferable to reduce incidence of external light from the stepped surface 122. This is because the occurrence of a ghost due to external light incident from the stepped surface 122 can be reduced. Specifically, blackening or mirror finishing is performed on the stepped surface 122. As a result, incidence of external light from the stepped surface 122 can be reduced, and image quality can be further improved.

### [Another Configuration of Image Display Device]

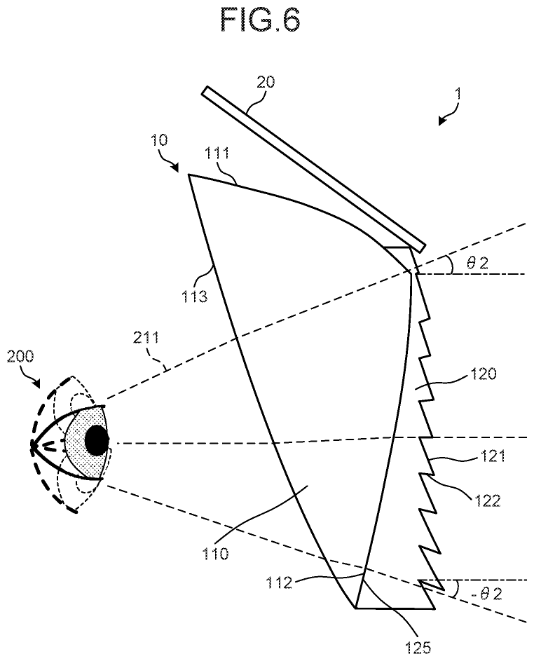

FIG. 6 is a cross-sectional view illustrating another configuration example of the image display device according to the second embodiment of the present disclosure. The present drawing is a schematic cross-sectional view illustrating a configuration example of the image display device 1, similarly to FIG. 5. The second prism 120 in the drawing is different from the image display device 1 in FIG. 5 in that the stepped surface 122 inclined along the optical path 211 is included in consideration of the movement of the eyeball 200.

The present drawing is a diagram illustrating an example of a case where the stepped surface 122 inclined along the optical path 211 is arranged assuming a case where the eyeball 200 moves. Since the optical element 10 of the present disclosure has a wide angle of view, it is also assumed that the user moves the eyeball 200 and gazes at the outside world. Therefore, the stepped surface 122 can be configured to be inclined along the optical path 211 when the eyeball 200 moves. In this case, an angle θ2 of the stepped surface 122 at the end portion of the second prism 120 can be set to, for example, an angle of a value “24”. As a result, it is possible to further reduce the occurrence of a ghost when the eyeball 200 is moved to gaze at the outside world.

Other configurations of the image display device 1 other than this are similar to the configuration of the image display device 1 in the first embodiment of the present disclosure, and thus the description thereof will be omitted.

As described above, the optical element 10 according to the second embodiment of the present disclosure can reduce the occurrence of a ghost by using the second prism 120 including the external light incident surface 121 having the stepped surface 122 inclined along the optical path from the observation portion. As a result, the image quality of an image based on external light can be improved.

### 3. Third Embodiment

The image display device 1 of the first embodiment described above uses the second prism 120 including the external light incident surface 121 having the plurality of stepped surfaces 122. On the other hand, an image display device 1 according to a third embodiment of the present disclosure is different from the above-described first embodiment in that respective end portions of the stepped surfaces 122 are aligned with a vertical surface.

### [Configuration of Image Display Device]

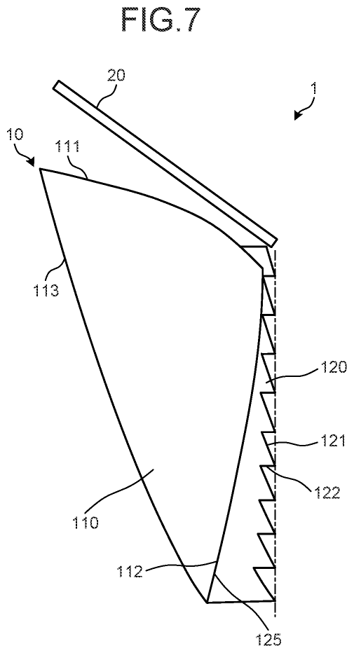

FIG. 7 is a cross-sectional view illustrating a configuration example of the image display device according to the third embodiment of the present disclosure. The present drawing is a schematic cross-sectional view illustrating a configuration example of the image display device 1, similarly to FIG. 2A. The second prism 120 in the drawing is different from the image display device 1 in FIG. 2A in aligning the end portions of the stepped surfaces 122.

The external light incident surface 121 of the second prism 120 in the drawing includes a plurality of stepped surfaces 122. These stepped surfaces 122 are configured in a shape in which their end portions are aligned with a vertical surface. Specifically, the end portions of the plurality of stepped surfaces 122 can be configured in a shape in contact with a virtual vertical plane indicated by a one-dot chain line in the drawing. As a result, the protrusion length of the front surface of the image display device 1 can be reduced. In addition, the image display device 1 can be configured to have a natural appearance.

Other configurations of the image display device 1 other than this are similar to the configuration of the image display device 1 in the first embodiment of the present disclosure, and thus the description thereof will be omitted.

As described above, the optical element 10 of the third embodiment of the present disclosure is configured in a shape in which the end portions of the plurality of stepped surfaces 122 of the external light incident surface 121 of the second prism 120 are aligned. As a result, the protrusion length of the front surface of the image display device 1 can be reduced.

Note that the configuration of the third embodiment of the present disclosure can be applied to other embodiments. Specifically, the shape of the end portion of the stepped surface 122 in FIG. 7 can be applied to the second embodiment of the present disclosure.

### (Effects)

The optical element 10 includes the first prism 110 and the second prism 120. The first prism 110 includes the incident surface 111, the semi-reflecting surface 112, and the emitting surface 113 each configured of a free-form surface, and the light of the display element 20 is incident from the incident surface 111, internally reflected between the emitting surface 113 and the semi-reflecting surface 112, and emitted from the emitting surface 113 to the observation portion of the light. The second prism 120 includes the external light incident surface 121 configured in a shape in which a free-form surface is divided by at least one stepped surface 122 and on which external light is incident, and the external light emitting surface 125 that emits the incident external light to the semi-reflecting surface 112. As a result, the thickness of the second prism 120 can be reduced.

Further, the second prism 120 may be disposed adjacent to the first prism 110. Thus, the optical element 10 can be downsized.

In addition, the second prism 120 may include the external light emitting surface 125 configured in the same shape as the semi-reflecting surface 112 and joined to the semi-reflecting surface 112. As a result, the incident external light can be emitted to the semi-reflecting surface 112.

In addition, the second prism 120 may emit the incident external light to the observation portion via the first prism 110. As a result, the image from the display element 20 can be superimposed on the image of the outside world.

In addition, the second prism 120 may include the external light incident surface 121 configured such that a free-form surface having the same shape as the emitting surface 113 is divided by at least one stepped surface 122. As a result, phase information of external light can be held.

In addition, the second prism 120 may include the external light incident surface 121 configured in a shape divided by the plurality of stepped surfaces 122.

In addition, the second prism 120 may include a plurality of stepped surfaces 122 having parallel inclinations. Thus, the processability of the step can be improved.

In addition, the second prism 120 may include a plurality of stepped surfaces 122 whose end portions are aligned with a vertical surface. As a result, the protrusion length of the optical element 10 can be reduced.

In addition, the second prism 120 may include the stepped surface 122 inclined along the optical path from the observation portion. As a result, internal reflection of external light in the second prism 120 can be reduced.

In addition, the second prism 120 may emit external light using the eyeball of the user as an observation portion.

In addition, the second prism 120 may include the stepped surface 122 inclined along the optical path according to the movement of the eyeball. As a result, internal reflection of external light in the second prism 120 can be reduced.

In addition, the second prism 120 may emit external light with the eyeball of the user as an observation portion, and the first prism 110 may allow light of the display element 20 arranged on the side of the eyeball of the user to enter the incident surface 111.

In addition, the second prism 120 may emit external light with the eyeball of the user as an observation portion, and the first prism 110 may allow light of the display element 20 arranged above the eyeball of the user to enter the incident surface 111.

The image display device 1 includes the display element 20, the first prism 110, and the second prism 120. The first prism 110 includes the incident surface 111, the semi-reflecting surface 112, and the emitting surface 113 each configured of a free-form surface, and the light of the display element 20 is incident from the incident surface 111, internally reflected between the emitting surface 113 and the semi-reflecting surface 112, and emitted from the emitting surface 113 to the observation portion of the light. The second prism 120 includes the external light incident surface 121 configured in a shape in which a free-form surface is divided by at least one stepped surface 122 and on which external light is incident, and the external light emitting surface 125 configured in the same shape as the semi-reflecting surface 112, joined to the semi-reflecting surface 112, and emitting the incident external light to the semi-reflecting surface 112, and the second prism 120 is disposed adjacent to the first prism 110 and emits the incident external light to the observation portion via the first prism 110. As a result, the thickness of the second prism 120 can be reduced.

Furthermore, the effects of the embodiments described in the present specification are merely examples and are not limited, and other effects may be provided.

Note that the present technology can also have the following configurations.

(1)

An optical element comprising:
a first prism that includes an incident surface, a semi-reflecting surface, and an emitting surface each configured of a free-form surface, and in which light of a display element is incident from the incident surface, is internally reflected between the emitting surface and the semi-reflecting surface, and is emitted from the emitting surface to an observation portion of the light; and
a second prism including an external light incident surface configured in a shape in which a free-form surface is divided by at least one stepped surface and on which external light is incident, and an external light emitting surface from which the incident external light is emitted to the semi-reflecting surface.
   (2)

The optical element according to the above (1), wherein the second prism is disposed adjacent to the first prism.

(3)

The optical element according to the above (2), wherein the second prism includes the external light emitting surface configured in the same shape as the semi-reflecting surface and joined to the semi-reflecting surface.

(4)

The optical element according to any one of the above (1) to (3), wherein the second prism emits the incident external light to the observation portion via the first prism.

(5)

The optical element according to any one of the above (1) to (4), wherein the second prism includes the external light incident surface configured in a shape in which the free-form surface having the same shape as the emitting surface is divided by the at least one stepped surface.

(6)

The optical element according to any one of the above (1) to (5), wherein the second prism includes the external light incident surface configured in a shape divided by a plurality of the stepped surfaces.

(7)

The optical element according to the above (6), wherein the second prism includes a plurality of the stepped surfaces having parallel inclinations.

(8)

The optical element according to the above (6) or (7), wherein the second prism includes a plurality of the stepped surfaces whose end portions are aligned with a vertical plane.

(9)

The optical element according to any one of the above (1) to (8), wherein the second prism includes the stepped surface inclined along an optical path from the observation portion.

(10)

The optical element according to the above (9), wherein the second prism emits the external light with an eyeball of a user as the observation portion.

(11)

The optical element according to the above (10), wherein the second prism includes the stepped surface inclined along the optical path according to a movement of the eyeball.

(12)

The optical element according to any one of the above (1) to (11), wherein
the second prism emits the external light with an eyeball of a user as the observation portion, and
light of the display element disposed on a side of the eyeball of the user is incident on the incident surface of the first prism.
   (13)

The optical element according to any one of the above (1) to (11), wherein
the second prism emits the external light with an eyeball of a user as the observation portion, and
light of the display element disposed above the eyeball of the user is incident on the incident surface of the first prism.
   (14)

An image display device comprising:
a display element;
a first prism that includes an incident surface, a semi-reflecting surface, and an emitting surface each configured of a free-form surface, and in which light of the display element is incident from the incident surface, is internally reflected between the emitting surface and the semi-reflecting surface, and is emitted from the emitting surface to an observation portion of the light; and
a second prism including an external light incident surface configured in a shape in which a free-form surface is divided by at least one stepped surface and on which external light is incident, and an external light emitting surface from which the incident external light is emitted to the semi-reflecting surface.

### REFERENCE SIGNS LIST

1 IMAGE DISPLAY DEVICE
10 OPTICAL ELEMENT
20 DISPLAY ELEMENT
30 HOUSING
110 FIRST PRISM
111 INCIDENT SURFACE
112 SEMI-REFLECTING SURFACE
113 EMITTING SURFACE
120 SECOND PRISM
121 EXTERNAL LIGHT INCIDENT SURFACE
125 EXTERNAL LIGHT EMITTING SURFACE

1. An optical element comprising:
a first prism that includes an incident surface, a semi-reflecting surface, and an emitting surface each configured of a free-form surface, and in which light of a display element is incident from the incident surface, is internally reflected between the emitting surface and the semi-reflecting surface, and is emitted from the emitting surface to an observation portion of the light; and
a second prism including an external light incident surface configured in a shape in which a free-form surface is divided by at least one stepped surface and on which external light is incident, and an external light emitting surface from which the incident external light is emitted to the semi-reflecting surface.

2. The optical element according to claim 1, wherein the second prism is disposed adjacent to the first prism.

3. The optical element according to claim 2, wherein the second prism includes the external light emitting surface configured in the same shape as the semi-reflecting surface and joined to the semi-reflecting surface.

4. The optical element according to claim 1, wherein the second prism emits the incident external light to the observation portion via the first prism.

5. The optical element according to claim 1, wherein the second prism includes the external light incident surface configured in a shape in which the free-form surface having the same shape as the emitting surface is divided by the at least one stepped surface.

6. The optical element according to claim 1, wherein the second prism includes the external light incident surface configured in a shape divided by a plurality of the stepped surfaces.

7. The optical element according to claim 6, wherein the second prism includes a plurality of the stepped surfaces having parallel inclinations.

8. The optical element according to claim 6, wherein the second prism includes a plurality of the stepped surfaces whose end portions are aligned with a vertical plane.

9. The optical element according to claim 1, wherein the second prism includes the stepped surface inclined along an optical path from the observation portion.

10. The optical element according to claim 9, wherein the second prism emits the external light with an eyeball of a user as the observation portion.

11. The optical element according to claim 10, wherein the second prism includes the stepped surface inclined along the optical path according to a movement of the eyeball.

12. The optical element according to claim 1, wherein
the second prism emits the external light with an eyeball of a user as the observation portion, and
light of the display element disposed on a side of the eyeball of the user is incident on the incident surface of the first prism.

13. The optical element according to claim 1, wherein
the second prism emits the external light with an eyeball of a user as the observation portion, and
light of the display element disposed above the eyeball of the user is incident on the incident surface of the first prism.

14. An image display device comprising:
a display element;
a first prism that includes an incident surface, a semi-reflecting surface, and an emitting surface each configured of a free-form surface, and in which light of the display element is incident from the incident surface, is internally reflected between the emitting surface and the semi-reflecting surface, and is emitted from the emitting surface to an observation portion of the light; and
a second prism including an external light incident surface configured in a shape in which a free-form surface is divided by at least one stepped surface and on which external light is incident, and an external light emitting surface from which the incident external light is emitted to the semi-reflecting surface.
